(19) United States
(12) Patent Application Publication
(10) Pub. No.: US 2007/0210586 A1
(43) Pub. Date: Sep. 13, 2007

(54) Hand tool having replaceable shank

(76) Inventor: Shu-Hui Yeh, Changhua Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/520,242

(22) Filed: Sep. 13, 2006

(30) Foreign Application Priority Data
Mar. 9, 2006 (TW) 095203910

(51) Int. Cl. E05C 19/12

(52) U.S. Cl. 292/113

(57) ABSTRACT

A hand tool includes a handle, a shank, a first locking plate, an elastic member, a second locking plate, a control knob, and a limit sleeve. Thus, the user only needs to push the control knob relative to the handle to lock or unlock the shank, so that the user can replace or adjust the shank relative to the handle by his one hand only, thereby saving the user's energy and manual work. In addition, the user only needs to push the control knob relative to the handle to lock or unlock the shank, so that the user can replace or adjust the shank relative to the handle easily and quickly, thereby facilitating the user replacing or adjusting the shank.

### BACKGROUND OF THE INVENTION

1. Field of the Invention

The present invention relates to a hand tool and, more particularly, to a hand tool, such as a screwdriver or the like.

2. Description of the Related Art

A conventional hand tool in accordance with the prior art shown in FIGS. 5-8 comprises a handle 70 having an end provided with a mounting portion 701 having an outer wall formed with a first chamber 703, a second chamber 704 and a middle chamber 705 located between the first chamber 703 and the second chamber 704 and an inner wall formed with a mounting hole 702 connected to the first chamber 703 and the second chamber 704, a shank 80 detachably mounted on the handle 70 and having an end inserted into the mounting hole 702 of the mounting portion 701 of the handle 70, a first locking plate 71 mounted in the first chamber 703 of the mounting portion 701 of the handle 70 and having a first passage 712 aligning with the mounting hole 702 of the mounting portion 701 of the handle 70 to allow passage of the shank 80, a second locking plate 72 mounted in the second chamber 704 of the mounting portion 701 of the handle 70 and having a second passage 722 aligning with the mounting hole 702 of the mounting portion 701 of the handle 70 to allow passage of the shank 80, an elastic member 73 mounted in the second chamber 704 of the mounting portion 701 of the handle 70 and biased between the second locking plate 72 and the mounting portion 701 of the handle 70 to bias the second locking plate 72 so that the second locking plate 72 is normally disposed at an oblique state to lock the shank 80, a control ring 74 rotatably mounted on the mounting portion 701 of the handle 70 and having an inner wall formed with a block 741 rotatable in the middle chamber 705 of the mounting portion 701 of the handle 70 and having a tapered press portion 742 that is rotatable to push the second locking plate 72 so that the second locking plate 72 is disposed at an upright state to unlock the shank 80, and a limit sleeve 75 mounted on the mounting portion 701 of the handle 70 and rested on the control ring 74 to limit the control ring 74.

The mounting portion 701 of the handle 70 has a periphery formed with a guide slot 708 connected to the middle chamber 705 to allow movement of the block 741 of the control ring 74. The second chamber 704 of the mounting portion 701 of the handle 70 has a side formed with a receiving space 707 to receive the elastic member 73, and the first chamber 703 of the mounting portion 701 of the handle 70 has a side formed with a slot 706. The limit sleeve 50 has an inner wall formed with a plug 751 inserted into the slot 706 of the mounting portion 701 of the handle 70. The limit sleeve 50 has an end face formed with a passage 752 aligning with the mounting hole 702 of the mounting portion 701 of the handle 70 to allow passage of the shank 80. The first locking plate 71 has two protruding sides 711 rested on two opposite sides of the first chamber 703 of the mounting portion 701 of the handle 70. The second locking plate 72 has two protruding sides 721 rested on two opposite sides of the second chamber 704 of the mounting portion 701 of the handle 70.

As shown in FIG. 7, the second locking plate 72 is normally disposed at an oblique state by an elastic force of the elastic member 73 to lock the shank 80.

As shown in FIG. 8, the control ring 74 is rotatable relative to the mounting portion 701 of the handle 70, so that the block 741 of the control ring 74 is rotatable from the guide slot 708 into the middle chamber 705 of the mounting portion 701 of the handle 70, and the tapered press portion 742 of the block 741 is rotatable to push the second locking plate 72 so that the second locking plate 72 is disposed at an upright state to unlock the shank 80. Thus, the shank 80 is detached from the handle 70 for replacement of the shank 80.

After the shank 80 is inserted into the mounting hole 702 of the mounting portion 701 of the handle 70 again, the control ring 74 is rotatable relative to the mounting portion 701 of the handle 70, so that the block 741 of the control ring 74 is rotatable from the middle chamber 705 into the guide slot 708 of the mounting portion 701 of the handle 70, and the tapered press portion 742 of the block 741 is rotatable to detach from the second locking plate 72 so that the second locking plate 72 is disposed at an oblique state by the restoring force of the elastic member 73 to lock the shank 80.

However, the user has to rotate the control ring 74 successively to lock or unlock the shank 80, so that the user cannot mount or replace the shank 80 easily and quickly, thereby causing inconvenience to the user in assembly and replacement of the shank 80. In addition, the user has to hold the handle 70 by his one hand and to rotate the control ring 74 by his other hand, thereby wasting the user's energy and manual work.

### BRIEF SUMMARY OF THE INVENTION

The primary objective of the present invention is to provide a hand tool having a replaceable shank.

Another objective of the present invention is to provide a hand tool, wherein the user only needs to push the control knob relative to the handle to lock or unlock the shank, so that the user can replace or adjust the shank relative to the handle by his one hand only, thereby saving the user's energy and manual work.

A further objective of the present invention is to provide a hand tool, wherein the user only needs to push the control knob relative to the handle to lock or unlock the shank, so that the user can replace or adjust the shank relative to the handle easily and quickly, thereby facilitating the user replacing or adjusting the shank.

A further objective of the present invention is to provide a hand tool, wherein after the force applied on the control knob is removed, the first locking plate and the control knob are returned to the original state by the restoring force of the elastic member to lock the shank, so that the shank is locked automatically, thereby facilitating the user mounting the shank.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hand tool in accordance with the preferred embodiment of the present invention.

FIG. 2 is an exploded perspective view of the hand tool as shown in FIG. 1.

FIG. 2A is a perspective view of a control knob of the hand tool as shown in FIG. 2.

FIG. 3 is a plan cross-sectional view of the hand tool as shown in FIG. 1.

FIG. 4 is a schematic operational view of the hand tool as shown in FIG. 3.

FIG. 5 is a perspective view of a conventional hand tool in accordance with the prior art.

FIG. 6 is an exploded perspective view of the conventional hand tool as shown in FIG. 5.

FIG. 7 is a plan cross-sectional view of the conventional hand tool as shown in FIG. 5.

FIG. 8 is a schematic operational view of the conventional hand tool as shown in FIG. 7.

### DETAILED DESCRIPTION OF THE INVENTION

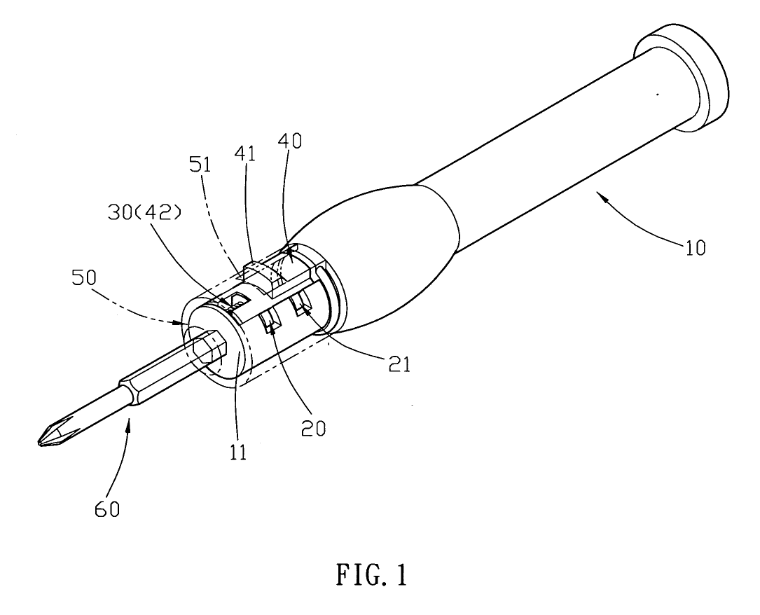

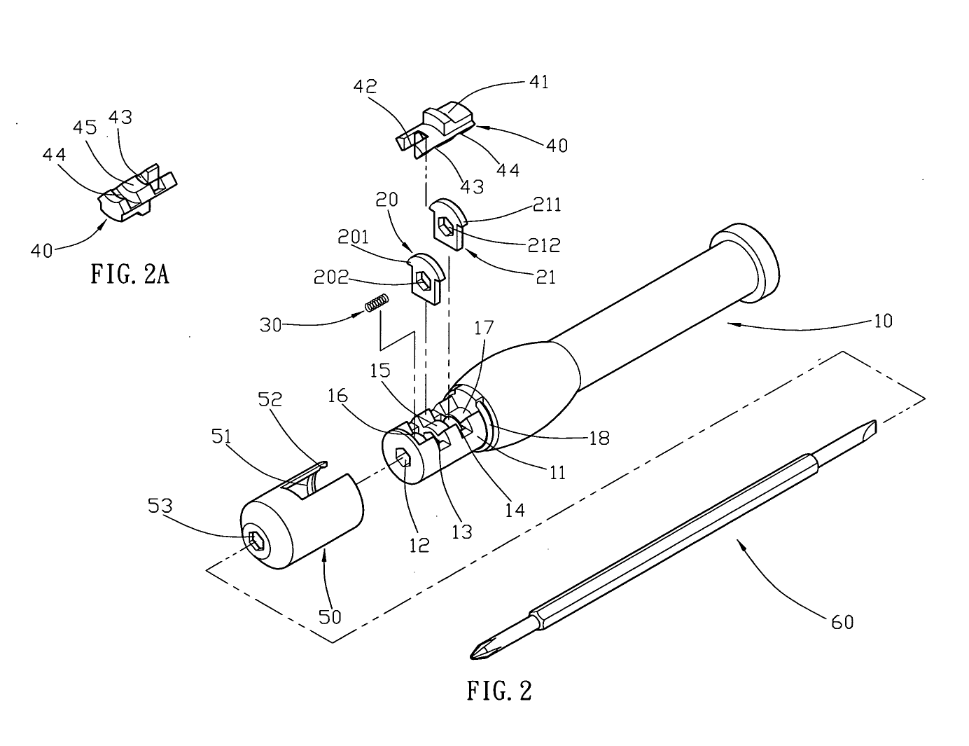

Referring to the drawings and initially to FIGS. 1-3, a hand tool in accordance with the preferred embodiment of the present invention comprises a handle 10 having an end provided with a protruding mounting portion 11 having an outer wall formed with a first chamber 13, a second chamber 14 and a displacement space 15 located between the first chamber 13 and the second chamber 14 and an inner wall formed with a mounting hole 12 connected to the first chamber 13 and the second chamber 14, a shank 60 detachably mounted on the handle 10 and having an end inserted into the mounting hole 12 of the mounting portion 11 of the handle 10, a first locking plate 20 mounted in the first chamber 13 of the mounting portion 11 of the handle 10 and having a first passage 202 aligning with the mounting hole 12 of the mounting portion 11 of the handle 10 to allow passage of the shank 60, an elastic member 30 mounted in the first chamber 13 of the mounting portion 11 of the handle 10 and biased between the first locking plate 20 and the mounting portion 11 of the handle 10 to bias the first locking plate 20 so that the first locking plate 20 is normally disposed at an oblique state to lock the shank 60, a second locking plate 21 mounted in the second chamber 14 of the mounting portion 11 of the handle 10 and having a second passage 212 aligning with the mounting hole 12 of the mounting portion 11 of the handle 10 to allow passage of the shank 60, a control knob 40 movably mounted on the mounting portion 11 of the handle 10 and having a first side formed with a protruding push portion 45 (see FIG. 2A) movably mounted in the displacement space 15 of the mounting portion 11 of the handle 10 and movable toward the first locking plate 20 to push the first locking plate 20 toward the elastic member 30 so that the first locking plate 20 is disposed at an upright state to unlock the shank 60, and a limit sleeve 50 mounted on the mounting portion 11 of the handle 10 and rested on the control knob 40 to limit the control knob 40 on the mounting portion 11 of the handle 10.

The handle 10 has an annular locking rib 18 located at a connection between the mounting portion 11 and the end of the handle 10. The first chamber 13 of the mounting portion 11 of the handle 10 has a side formed with a receiving space 16 to receive the elastic member 30, and the second chamber 14 of the mounting portion 11 of the handle 10 has a side formed with a receiving space 17 to receive the control knob 40.

The first locking plate 20 has two protruding sides 201 rested on two opposite sides of the first chamber 13 of the mounting portion 11 of the handle 10.

The second locking plate 21 has two protruding sides 211 rested on two opposite sides of the second chamber 14 of the mounting portion 11 of the handle 10.

The control knob 40 has a second side formed with a protruding operation block 41 to facilitate a user holding and moving the control knob 40. The control knob 40 has an end portion formed with an opening 42 to receive the elastic member 30. The push portion 45 of the control knob 40 is located between the first locking plate 20 and the second locking plate 21. The first side of the control knob 40 has a first slideway 43 (see FIG. 2A) to receive and allow movement of an upper portion of the first locking plate 20, and a second slideway 44 (see FIG. 2A) to receive and allow movement of an upper portion of the second locking plate 21.

The limit sleeve 50 is enclosed around the control knob 40 and has a peripheral wall formed with a guide slot 51 in which the operation block 41 of the control knob 40 is movable. The limit sleeve 50 has an inner wall formed with an annular locking groove 52 locked on the locking rib 18 of the handle 10 to attach the limit sleeve 50 onto the handle 10. The limit sleeve 50 has an end face formed with a passage 53 aligning with the mounting hole 12 of the mounting portion 11 of the handle 10 to allow passage of the shank 60.

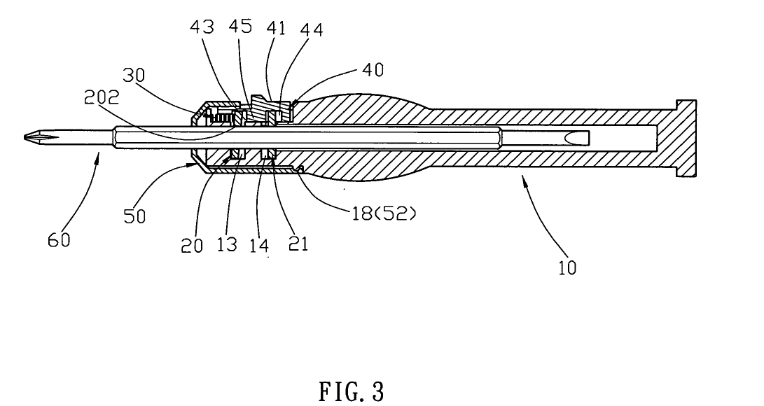

As shown in FIG. 3, the first locking plate 20 is normally disposed at an oblique state by an elastic force of the elastic member 30 so that the first passage 202 of the first locking plate 20 is rested on the shank 60 in an oblique manner to lock the shank 60.

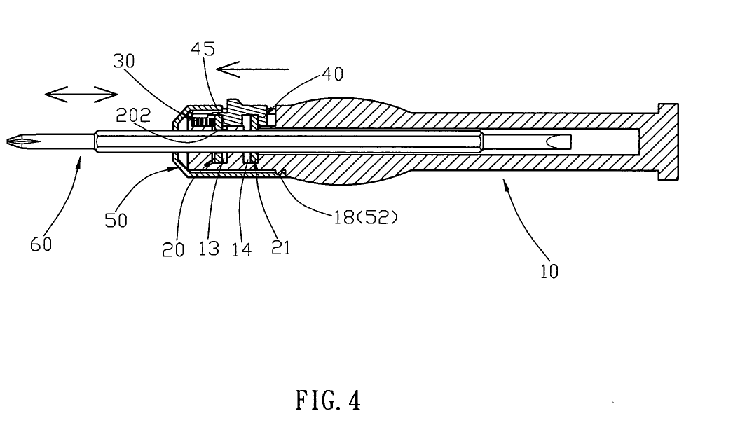

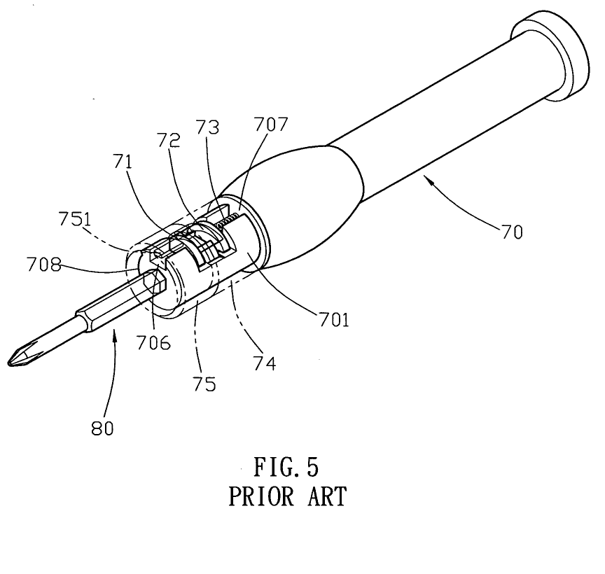

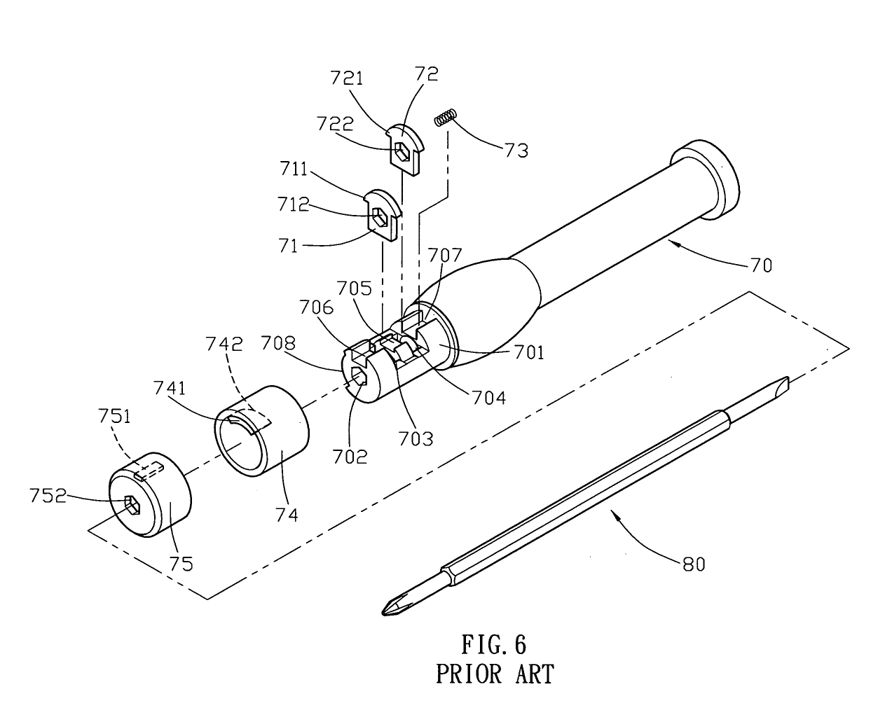

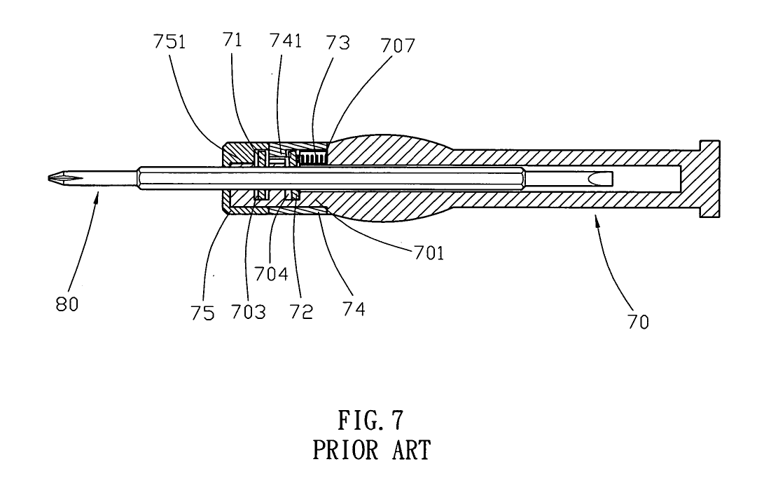

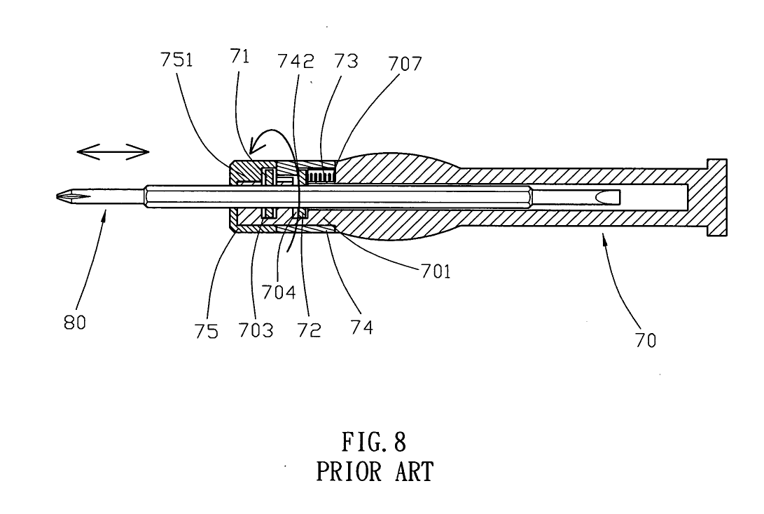

As shown in FIG. 4, the push portion 45 of the control knob 40 is movable toward the first locking plate 20 by push of the operation block 41 of the control knob 40 to push the first locking plate 20 toward the elastic member 30 so that the first locking plate 20 is disposed at an upright state to unlock the shank 60. Thus, the shank 60 is detached from or movable relative to the handle 10 for replacement or adjustment of the shank 60. After the shank 60 is inserted into the mounting hole 12 of the mounting portion 11 of the handle 10 again, the first locking plate 20 is normally disposed at an oblique state by the restoring force of the elastic member 30 so that the first passage 202 of the first locking plate 20 is rested on the shank 60 in an oblique manner to lock the shank 60.

Accordingly, the user only needs to push the control knob 40 relative to the handle 10 to lock or unlock the shank 60, so that the user can replace or adjust the shank 60 relative to the handle 10 by his one hand only, thereby saving the user's energy and manual work. In addition, the user only needs to push the control knob 40 relative to the handle 10 to lock or unlock the shank 60, so that the user can replace or adjust the shank 60 relative to the handle 10 easily and quickly, thereby facilitating the user replacing or adjusting the shank 60. Further, after the force applied on the control knob 40 is removed, the first locking plate 20 and the control knob 40 are returned to the original state by the restoring force of the elastic member 30 to lock the shank 60, so that the shank 60 is locked automatically, thereby facilitating the user mounting the shank 60.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hand tool, comprising:
a handle having an end provided with a protruding mounting portion having an outer wall formed with a first chamber, a second chamber and a displacement space located between the first chamber and the second chamber and an inner wall formed with a mounting hole connected to the first chamber and the second chamber;
a shank detachably mounted on the handle and having an end inserted into the mounting hole of the mounting portion of the handle;
a first locking plate mounted in the first chamber of the mounting portion of the handle and having a first passage aligning with the mounting hole of the mounting portion of the handle to allow passage of the shank;
an elastic member mounted in the first chamber of the mounting portion of the handle and biased between the first locking plate and the mounting portion of the handle to bias the first locking plate so that the first locking plate is normally disposed at an oblique state to lock the shank;
a second locking plate mounted in the second chamber of the mounting portion of the handle and having a second passage aligning with the mounting hole of the mounting portion of the handle to allow passage of the shank;
a control knob movably mounted on the mounting portion of the handle and having a first side formed with a protruding push portion movably mounted in the displacement space of the mounting portion of the handle and movable toward the first locking plate to push the first locking plate toward the elastic member so that the first locking plate is disposed at an upright state to unlock the shank;
a limit sleeve mounted on the mounting portion of the handle and rested on the control knob to limit the control knob on the mounting portion of the handle.

2. The hand tool in accordance with claim 1, wherein the handle has an annular locking rib located at a connection between the mounting portion and the end of the handle, and the limit sleeve has an inner wall formed with an annular locking groove locked on the locking rib of the handle to attach the limit sleeve onto the handle.

3. The hand tool in accordance with claim 1, wherein the first chamber of the mounting portion of the handle has a side formed with a receiving space to receive the elastic member.

4. The hand tool in accordance with claim 1, wherein the second chamber of the mounting portion of the handle has a side formed with a receiving space to receive the control knob.

5. The hand tool in accordance with claim 1, wherein the control knob has a second side formed with a protruding operation block to facilitate a user holding and moving the control knob.

6. The hand tool in accordance with claim 5, wherein the limit sleeve has a peripheral wall formed with a guide slot in which the operation block of the control knob is movable.

7. The hand tool in accordance with claim 1, wherein the control knob has an end portion formed with an opening to receive the elastic member.

8. The hand tool in accordance with claim 1, wherein the first locking plate has two protruding sides rested on two opposite sides of the first chamber of the mounting portion of the handle.

9. The hand tool in accordance with claim 1, wherein the second locking plate has two protruding sides rested on two opposite sides of the second chamber of the mounting portion of the handle.

10. The hand tool in accordance with claim 1, wherein the push portion of the control knob is located between the first locking plate and the second locking plate.

11. The hand tool in accordance with claim 1, wherein the first side of the control knob has a first slideway to receive and allow movement of an upper portion of the first locking plate, and a second slideway to receive and allow movement of an upper portion of the second locking plate.

12. The hand tool in accordance with claim 1, wherein the limit sleeve is enclosed around the control knob.

13. The hand tool in accordance with claim 1, wherein the limit sleeve has an end face formed with a passage aligning with the mounting hole of the mounting portion of the handle to allow passage of the shank.

14. The hand tool in accordance with claim 1, wherein the first locking plate is normally disposed at an oblique state by an elastic force of the elastic member so that the first passage of the first locking plate is rested on the shank in an oblique manner to lock the shank.

15. The hand tool in accordance with claim 5, wherein the push portion of the control knob is movable toward the first locking plate by push of the operation block of the control knob to push the first locking plate toward the elastic member so that the first locking plate is disposed at an upright state to unlock the shank.
